(19) United States
(12) Patent Application Publication
(10) Pub. No.: US 2021/0117625 A1
(43) Pub. Date: Apr. 22, 2021

(54) SEMANTIC PARSING OF NATURAL LANGUAGE QUERY

(71) Applicant: Microsft Technology Licensing, LLC, Redmond, WA (US)

(72) Inventors: Yan Gao, Redmond, WA (US); Bo ZHANG, Redmond, WA (US); Jian-Guang LOU, Redmond, WA (US); Dongmei ZHANG, Beijing (CN)

(21) Appl. No.: 17/057,092

(22) PCT Filed: Jun. 17, 2019
(86) PCT No.: PCT/US2019/037410

§ 371 Date: Nov. 19, 2020

(30) Foreign Application Priority Data
Jun. 29, 2018 (CN) 201810714156.4

(51) Int. Cl. G06F 40/30; G06F 16/332; G06F 40/205; G06N 5/02; G06N 3/02

(52) U.S. Cl. CPC G06F 40/30; G06F 16/3329; G06N 3/02; G06N 5/02; G06F 40/205

(57) ABSTRACT

According to implementations of the subject matter described herein, there is proposed a solution for semantic parsing of a natural language query. In this solution, a plurality of words in a natural language query for a data set are replaced with a plurality of predetermined symbols to obtain an abstracted utterance. The abstracted utterance is parsed into a plurality of logical representations by applying different deduction rule sets to the abstracted utterance, each logical representation corresponding to a predictive semantic of the natural language query. A logical representation is selected based on the predictive semantics corresponding to the plurality of logical representations for generating a computer-executable query for the data set. Through this solution, a natural language query is converted to a computer-executable query quickly in a data-agnostic and syntax-agnostic manner.

### BACKGROUND

Users may expect to query for useful information from a knowledge base for the purpose of requirements in work, study, research, and so on. In order to implement the query, a machine language, such as Structured Query Language (SQL), SPARQL Protocol and RDF Query Language (SPARQL), needs to be used to initiate a query to a computer. This requires the user an expert in such machine language. Machine query languages may also change as the knowledge base format changes, the data retrieval technique changes, and so on. This brings more difficulty to the data retrieval procedure by the user.

For the convenience of the user, it is expected that the computer supports use of flexible natural languages to initiate queries. In such case, the computer operating on the basis of the machine query language shall understand the user's questions so as to convert the natural language query into a computer-executable query. However, converting from the natural language to machine language is a challenging task. The difficulty of this task lies in how to parse the real semantic in the natural language query correctly, which is actually a semantic parsing problem faced in the natural language processing. Although the semantic analysis of natural language has been developed for a long time, due to the complexity and variability of vocabulary, grammar and structure of the natural languages, there is still no a general solution to accurately understand semantics of various natural language-based utterances occurred in various scenarios.

### SUMMARY

In accordance with implementations of the subject matter described herein, there is proposed a solution for semantic parsing of a natural language query. In this solution, a plurality of words in a natural language query for a data set are replaced with a plurality of predetermined symbols to obtain an abstracted utterance. The abstracted utterance is parsed into a plurality of logical representations by applying different deduction rule sets to the abstracted utterance, each logical representation corresponding to a predictive semantic of the natural language query. A logical representation is selected based on the predictive semantics corresponding to the plurality of logical representations for generating a computer-executable query for the data set. Through this solution, a natural language query is converted to a computer-executable query quickly in a data-agnostic and syntax-agnostic manner.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing environment in which implementations of the subject matter described herein can be implemented;

FIG. 2 illustrates a block diagram of a semantic parsing module for parsing a natural language query according to an implementation of the subject matter described herein;

FIG. 3 illustrates a schematic diagram of an example of data abstraction according to an implementation of the subject matter described herein;

FIG. 4 illustrates a schematic diagram of a logic representation in a form of a semantic parsing tree according to an implementation of the subject matter described herein;

FIG. 5 illustrates a schematic diagram of a model for determining a semantic confidence according to an implementation of the subject matter described herein;

FIG. 6 illustrates a flowchart of a process for parsing a natural language query according to an implementation of the subject matter described herein.

Throughout the drawings, the same or similar reference symbols refer to the same or similar elements.

### DETAILED DESCRIPTION

The subject matter described herein will now be discussed with reference to several example implementations. It is to be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The terms “one implementation” and “an implementation” are to be read as “at least one implementation.” The term “another implementation” is to be read as “at least one other implementation.” The terms “first,” “second,” and the like may refer to different or same objects. Other definitions, either explicit or implicit, may be included below.

As used herein, the term “natural language” refers to a daily language used by human beings for written or verbal communication. Examples of natural languages include Chinese, English, German, Spanish, French, and the like. The term “machine language” refers to instructions that are directly executable by a computer, which is also referred to as a computer language or a computer programming language. Examples of machine language include Structured Query language (SQL), SPARQL protocol and RDF Query Language (SPARQL), C/C+ language, Java language, Python language, and the like. The machine query language is a machine language, such as SQL, SPARQL, etc., used to guide the computer to perform a query operation. Human being may directly understand natural language with their intelligence, while computers can only directly understand the machine language so as to perform one or more operations. Unless being converted, it is difficult for the computers to understand the grammar and syntax of a natural language.

As mentioned above, semantic parsing is a burden in converting a natural language query into a computer-executable query. It has been found difficult to obtain a good general-purpose semantic parsing solution. Many proposed general-purpose semantic parsing solutions rely heavily on grammars of different natural languages. Some solutions may be used to solve semantic parsing problems for specific applications, such as data query scenarios. These solutions usually rely on pre-analysis of a known knowledge base and thus can only achieve good performance for the limited knowledge base. If a query is to be performed for a new knowledge base, it is necessary to redesign an algorithm or to re-train a model using the new data. This process is time-consuming, affects user experience, and is especially unfavorable in data query where the query results are expected to be presented efficiently. Therefore, it is desirable to propose a semantic parsing solution that can be implemented quickly in a data-agnostic and syntax-agnostic manner.

### Example Environment

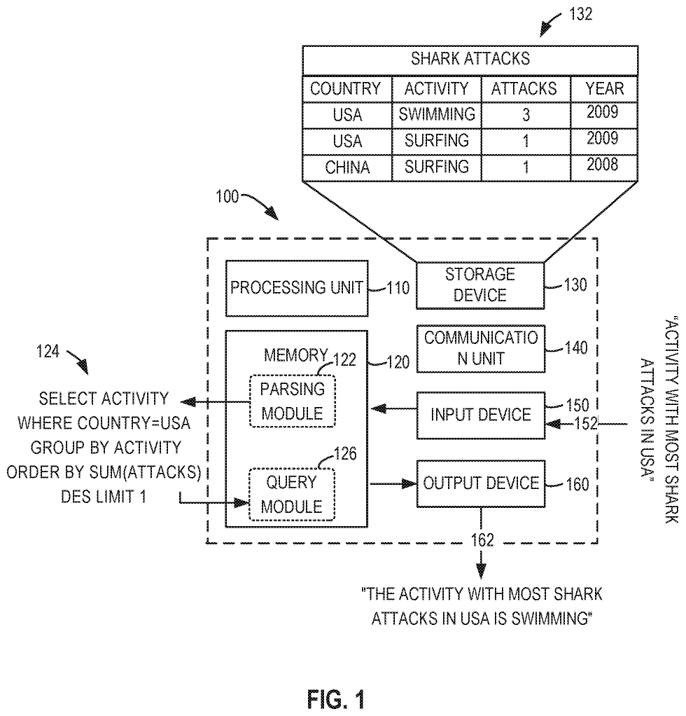

The basic principles and several example implementations of the subject matter described herein are described below with reference to the accompanying drawings. FIG. 1 illustrates a block diagram of a computing device 100 in which implementations of the subject matter described herein can be implemented. It would be appreciated that the computing device 100 shown in FIG. 1 is merely for illustration and should not be considered as any limitation to the functionality and scope of the implementations of the subject matter described herein in any way. As shown in FIG. 1, the computing device 100 includes a computing device 100 in form of general-purpose computing device. Components of the computing device 100 may include, but are not limited to, one or more processors or processing units 110, a memory 120, a storage device 130, one or more communication units 140, one or more input devices 150, and one or more output devices 160.

In some implementations, the computing device 100 may be implemented as any user terminal or service terminal. The service terminal may be a server or large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 100 can support any type of interface to a user (such as “wearable” circuitry and the like).

The processing unit 110 may be a physical or virtual processor and can implement various processes based on programs stored in the memory 120. In a multi-processor system, a plurality of processing units execute computer-executable instructions in parallel so as to improve parallel processing capability of the computing device 100. The processing unit 110 may also be referred to as a central processing unit (CPU), a microprocessor, a controller and a microcontroller.

The computing device 100 usually includes various computer storage medium. The computer storage medium may be any medium accessible by the computing device 100, including but not limited to volatile and non-volatile medium, or detachable and non-detachable medium. The memory 120 may be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof. The storage device 130 may be any detachable or non-detachable medium and may include machine-readable medium such as memory, a flash drive, a magnetic disk or any other medium, which may be used for storing information and/or data and may be accessed in the computing device 100.

The computing device 100 may further include additional detachable/non-detachable, volatile/non-volatile memory medium. Although not shown in FIG. 1, it is possible to provide a disk drive for reading from or writing into a detachable and non-volatile disk and an optical disk drive for reading from and writing into a detachable non-volatile optical disc. In such cases, each drive may be connected to a bus (not shown) via one or more data medium interfaces.

The communication unit 140 communicates with a further computing device via the communication medium. In addition, the functions of components in the computing device 100 may be implemented by a single computing cluster or multiple computing machines that can communicate via communication connections. Therefore, the computing device 100 can operate in a networked environment using a logical connection with one or more other servers, network personal computers (PCs) or further general network nodes.

The input device 150 may include one or more of various input devices, such as a mouse, keyboard, tracking ball, voice-input device, and the like. The output device 160 may include one or more of various output devices, such as a display, loudspeaker, printer, and the like. By means of the communication unit 140, the computing device 100 can further communicate with one or more external devices (not shown) such as the storage devices and display device, with one or more devices enabling the user to interact with the computing device 100, or any devices (such as a network card, a modem and the like) enabling the computing device 100 to communicate with one or more other computing devices, if required. Such communication may be performed via input/output (I/O) interfaces (not shown).

In some implementations, as an alternative of being integrated on a single device, some or all components of the computing device 100 may also be arranged in form of cloud computing architecture. In the cloud computing architecture, the components may be provided remotely and work together to implement the functions described in the subject matter described herein. In some implementations, cloud computing provides computing, software, data access and storage service, which will not require end users to be aware of the physical positions or configurations of the systems or hardware providing these services. In various implementations, the cloud computing provides the services via a wide region network (such as Internet) using proper protocols. For example, a cloud computing provider provides applications over the wide region network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functions described herein from a service provider at a remote location. Alternatively, they may be provided from a conventional server or installed directly or otherwise on a client device.

The computing device 100 may be used to implement semantic parsing of a natural language query in implementations of the subject matter described herein. The memory 120 may include one or more modules having one or more program instructions. These modules may be accessed and executed by processing unit 110 to perform functions of the various implementations described herein. The memory 120 may include a parsing module 122 for semantic parsing. The memory 120 may further include a query module 126 for data query.

Upon performing semantic parsing, the computing device 100 can receive a natural language query 152 through the input device 150. The natural language query 152 may be input by the user and includes an utterance based the natural language, such as one or more words. In the example of FIG. 1, the natural language query 152 is an utterance of “Activity with most shark attack in USA” written in English. The natural language query 152 may be input for querying a particular knowledge base, such as a data set 132 stored in the storage device 130. The data set 132 is organized as a table, including a table name “Shark attacks”, a plurality of column named “Country,” “Activity,” “Attacks,” and “Year,” and data items defined by rows and columns, such as “USA” and the like.

The natural language query 152 is input to the parsing module 122 in the memory 120. The parsing module 122 may parse the natural language query 152 and generate a computer-executable query 124 for the data set 132. The computer-executable query 124 is a query written in a machine language, particularly, in a machine query language. In the example of FIG. 1, the computer-executable query 124 is a query of “Select Activity where Country=USA GROUP BY activity Order by sum (Attacks) DES LIMIT 1” written in the SQL language.

The computer-executable query 124 may be provided to the query module 126. The query module 126 executes the computer-executable query 124 to search the data set 132 for activities that cause the most shark attacks in the United States. The query module 126 provides a query result 160 to the output device 160, and the query result is output by the output device 160 as a response to the natural language query 152. In the example of FIG. 1, the query result 160 is written as a natural language utterance “The activity with most shark attacks in USA is swimming.” Although the query result is illustrated as a natural language utterance, in other implementations, the query result may also be presented as a value, table, graph, or other forms such as audio and video, depending on the specific query result type and actual needs. Implementations in this aspect are not limited.

It should be appreciated that the natural language query 152, the computer-executable query 124, the query result 162, and the data set 132 illustrated in FIG. 1 are for illustrative purposes only and are not intended to be any limitation of the implementation of the subject matter described herein. Although SQL is used as an example, the natural language query may be converted to a computer-executable query in any other machine language form. The data set 132 or other knowledge base for the query may be stored locally at the computing device 10 or stored in an external storage device or database accessible via the communication unit 140. In some implementations, the computing device 100 may perform only semantic parsing work and provide a parsing result to other devices for enabling the generation of computer-executable queries and/or the determination of query results. Accordingly, the memory 120 of the computing device 100 may not include the query module 126.

### Work Principle

In accordance with implementations of the subject matter described herein, there is provided a solution for semantic parsing of a natural language query. This solution involves semantic parsing of the natural language query for a data set organized in a table. In this solution, words in a natural language query are replaced with predetermined symbols to generate an abstracted utterance. The abstracted utterance is parsed into a plurality of logical representations by applying different deduction rule sets to the abstracted utterance, each logical representation corresponding to a predictive semantic of the natural language query. A logical representation is selected based on the predictive semantics to generate a computer-executable query for the data set. In this way, the conversion from the natural language query to the computer-executable query may be quickly implemented in a data-agnostic and syntax-agnostic manner.

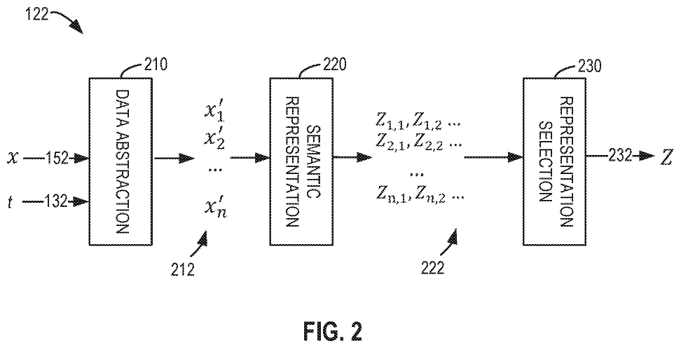

FIG. 2 illustrates a parsing module 122 for parsing a natural language query in accordance with some implementations of the subject matter described herein. The parsing module 122 may be implemented in the computing device 100 of FIG. 1. As shown, the parsing module 122 includes a data abstraction module 210, a semantic representation module 220, and a representation selection module 230.

The data abstraction module 210 receives the natural language query 152 for a particular data set. The natural language query 152 may be considered as a natural language-based utterance that includes a plurality of words. Depending on the language employed by the natural language query 152, the plurality of words may be words contained in one or more natural languages. The set data set is organized as a table. The data set may include a table name, row names and/or column names, and data items defined by rows and columns. An example of the data set is the data set 132 as shown in FIG. 1. The data set is the object of the natural language query 152, which means that the query result of the natural language query 152 is expected to be obtained from this data set. In some implementations, the natural language used by the natural language query 152 may be the same as the natural language for presenting the data set. In some implementations, the two natural languages may be different. As will be understood from the following discussion, different natural languages only have impact on how the data abstraction process replaces the symbols, which may be achieved through inter-translation of the natural languages.

In accordance with an implementation of the subject matter described herein, data abstraction module 210 performs a data abstraction operation. Specifically, the data abstraction module 210 converts the natural language query 152 into an abstracted utterance 212 by replacing the plurality of words in the natural language query 152 with a plurality of predetermined symbols. The order of the plurality of predetermined symbols in the abstracted utterance 212 is the same as the order of the plurality of words in the natural language query 152. The data abstraction is to map the original vocabulary in the natural language query 152 to a limited number of predetermined symbols in a predetermined dictionary. This may reduce the difficulty of parsing too many words in different natural languages. The predetermined symbols are symbols set for a specific scenario, particularly for a data query scenario of a table where some symbols may be mapped to table-related information. Through data abstraction, the table-related information may be abstracted from the natural language query 152. The data abstraction process will be described in detail below.

In some implementations, in the word-symbol replacement process, depending on the mapping relationship, the same word or the same set of words in the natural language query 152 may be replaced with different predetermined symbols. Accordingly, data abstraction module 210 may convert one or more different abstracted utterances 212 from the natural language query 152. It is assumed that the natural language query 152 is represented as x, and the data abstraction module 210 generates n abstracted utterances 212 (n≥1), represented as x₁′, x₂′, . . . , xₙ″, respectively.

The abstracted utterance 212 is provided to the semantic representation module 220. The semantic representation module 220 parses the abstracted utterance 212 into a plurality of logical representations 222 by applying different deduction rule sets to the abstracted utterance 212. In some implementations, the logical representation 222 is defined by a plurality of predetermined symbols and the applied deduction rules, and thus is a computer-interpretable representation form. The deduction rules are used to deduce possible semantics from the words (namely, symbols) of the abstracted utterance 212. Thus, each logical representation 222 may correspond to a predicted semantic of the natural language query 152.

A deduction rule may apply on one or more predetermined symbols of the abstracted utterance 212. In some implementations, each deduction rule defines at least one of: an application condition of the deduction rule, a deduction rule from at least one predetermined symbol to a deduced symbol, a predicate logic corresponding to the deduced symbol, and a property setting rule. The property setting rule defines how to set the property to which the deduced symbol is mapped. The deduction rules may be designed for a specific scenario, especially for a data query scenario for a table. Each set of the deduction rules may include one or more deduction rules. One or more deduction rules included in different deduction rule sets are different. Therefore, different logical representations may be generated due to the application of different deduction rules. By applying the deduction rules, a logical representation may correspond to a prediction semantic of the natural language query.

In some implementations, if the data abstraction module 210 provides a plurality of abstracted utterances 212, the semantic representation module 220 may apply different deduction rule sets to generate a plurality of logical representations for each of the abstracted utterances 212. If one or more abstracted utterances 212 are represented as x₁′, x₂′, . . . , xₙ′, the logical representations generated by these abstracted utterances may be represented as Z_{1,1}, Z_{1,2}, . . . ; Z_{2,1}, Z_{2,2}, . . . ; . . . ; Z_{n,1}, Z_{n,2}, . . . . The process of using the set of deduction rules to generate logical representations will be described in detail below.

A plurality of logical representations 222 are provided to the selection module 230. The selection module 230 selects, based on the predictive semantics corresponding to the plurality of logical representations 222, a logical representation 232 (represented as Z) for generating a computer-executable query for the data set. Since each logical representation is parsed from a corresponding abstracted utterance 222 through a different deduction rule, it is possible to select, from the plurality of logical representations, a logical representation of which the predictive semantic matches the true semantic of the natural language query 152 more closely, to generate the computer-executable query. As discussed in more detail below, in some implementations, it is possible to measure whether the predictive semantic matches the actual semantic by determining a semantic confidence of each logical representation.

In some implementations, if a corresponding logical representation is parsed from a plurality of abstracted utterances 212, the selection module 230 may first select a logical representation from the logical representations parsed by each abstracted utterance 212, and the selected logical representation may correspond to a better semantic parsed on the basis of the corresponding abstracted utterance. Then, the selection module 230 may continue to filter the plurality of logical representations selected for the plurality of abstracted utterances to get a logical representation corresponding to the more matched semantic.

The logical representation 232 (denoted as Z) selected by the selection module 230, which is represented in a computer-interpretable form, may be used to generate the computer-executable query (e.g., the machine query language to be utilized) as required. In some implementations, the parsing module 122 may include another module for performing the generation of computer-executable query. In some other implementations, the selected logical representation may be provided to other modules or other devices in memory 120 of the computing device 100 for the generation of the computer-executable query.

In accordance with implementations of the subject matter described herein, it is possible to, rather than directly composing the natural language query into the computer-executable query, interpret the logical representation as the computer-executable query through the generation and selection of data abstractions and intermediate logical representations. In this process, the dictionary and deduction rules for semantic parsing are designed to be as simple as possible, and semantic parsing may be achieved only by learning surface features. This semantic parsing solution may obtain accurate results across languages and knowledge domains, enabling data-agnostic and syntax-agnostic fast semantic parsing. In some implementations, the predetermined symbols and deduction rules may be set based on expert knowledge, and thus may include different, more or fewer predetermined symbols and/or deduction rules as described herein. In general, a limited number of symbols and deduction rules may achieve good semantic parsing effects in the queries for the data sets in the form of a table.

FIG. 2 illustrates the example implementation of parsing a natural language query into a logical representation for generating a computer-executable query. The implementation of data abstraction, semantic representation, and representation selection included in this process will be further described in detail below.

### Data Abstraction

As discussed above, the data abstraction process of data abstraction module 210 depends on the predetermined symbols. The predetermined symbols are from a predetermined dictionary, also called a vocabulary. In some implementations, the symbols in the predetermined dictionary include predetermined symbols indicating table-related information or data, such as predetermined symbols indicating a table name, row and/or column names, and specific data items defined by a row and a column. Such predetermined symbols may be mapped to a property and a semantic of the table-related information, wherein the properties describe the basic information of the symbol, and the semantic characterizes the meaning of the symbol. As will be discussed below, such predetermined symbols may continue to deduce to obtain other symbols and thus may also referred to as metadata symbols included in a metadata symbol set. Some examples of the predetermined symbols in the metadata symbol set are given in Table 1 below. It would be appreciated that symbols of the English alphabet type in Table 1 are merely examples, and any other symbols may be used to indicate the table-related information.

TABLE 1
Metadata symbols

| Symbol | Property | Semantic |
|---|---|---|
| T | column | table |
| C | column, type | column of the table |
| V | value, column | general data item |
| N | value, column | value |
| D | value, column | time/date |

In Table 1, the semantic of the symbol T represents the whole table (namely, the data set), which has the property “column” (represented as col), which records names of one or more columns of the table included by the symbol; the semantic of the symbol C is the column of the table, and the symbol C has properties “column” (col) and “type” (which may be expressed as type). The property “type” records the type of data in a column, and the type may be selected from, for example, {number, string, date}. The symbols V, N, and D represent the data items defined by a row and a column of the table, and each have the properties “value” (which may be represented as value) and “column” (which may be represented as col), where the property “value” records specific information of data items defined by rows and columns, which corresponds to strings, values and dates/time of general data items, respectively, and the property “col” indicates columns corresponding to the symbols.

A predetermined symbol in the metadata symbol set has two functions. The function in the first aspect is using the symbol to deduce other symbols in the subsequent parsing as described above. The function in the other aspect is to generate the computer-executable query by considering the semantic and property to which the symbol is mapped.

In addition to the symbols indicating the table-related information, the symbols in the predetermined dictionary may also include important words in a given natural language or additional symbols indicating these important words. Such important words may include important stop words, such as “by,” “of,” “with” and the like in English. Some words related to data analysis and/or data aggregation may also be considered as important words in the data query scenario, such as “group,” “sort,” “different,” “sum,” “average,” “count” and so on in English. Important words that may be used as predetermined symbols can also include words related to comparison, such as “greater,” “than,” “less,” “between,” “most,” and the like in English. The predetermined symbols corresponding to such important words may be represented by the corresponding words in different natural languages. For example, the predetermined symbols are represented as “by,” “of,” “with” and the like. Alternatively, these words may be uniformly represented by other symbols that are distinguishable from predetermined symbols that indicate the table-related information. In this case, these predetermined symbols may be mapped to words in different natural languages.

In general, in order to make the predetermined dictionary simple, the number of predetermined symbols included therein may be a limited number. For example, it has been experimentally found that for English, approximately 400 predetermined symbols may be used to achieve a desired semantic analysis result. In some implementations, a special symbol can also be set to indicate an unknown word. The special symbol may be any symbol that is different from other predetermined symbols, such as “UNK.” It may be seen that all predetermined symbols are not specific to a certain data set or table, but are universal to all data sets or tables.

In the data abstraction process, various techniques may be employed to perform the matching of one or more words with predetermined symbols in the natural language query 152. In some implementations, the data abstraction module 210 segments (namely, word-segment) a plurality of words of the natural language query 152 and/or performs word form converting to obtain a plurality of groups of words, each group comprising one, two, or more words. In some implementations, since the word segmentation requires higher grammatical parsing, instead of performing word segmentation, the plurality of words are divided one by one. Then, the data abstraction module 210 determines which of the predetermined symbols should replace each group of words or each word based on sources of symbols in the predetermined symbols. Even though the plurality of words are divided sequentially, the data abstraction module 210 may traverse combinations of the plurality of words when replacement of predetermined symbols is performed. Typically, two or more adjacent words are used as a group of words.

Specifically, the data abstraction module 210 may identify whether one or more words of the plurality of words in natural language query 152 match the data in the data set (e.g., the data set 152). If the data abstraction module 210 identifies that one or more words of the plurality of words match the data in the data set, the word(s) is(are) replaced with a predetermined symbol indicating the table-related information, such as the predetermined symbols listed in Table 1 above. After the predetermined symbol is replaced, the predetermined symbol will be mapped to a property and a semantic associated with the information of the table, such as the mapping form of Table 1. In some implementations, since the predetermined symbols include predetermined symbols that are language-independent or support a plurality of languages, such as general values, dates, times (e.g., V, N, D) and the like, the data abstraction module 210 identifies values from the natural language query 152 before performing word segmentation and/or part-of-speech converting, and determines matched predetermined symbols by judging types of the identified values.

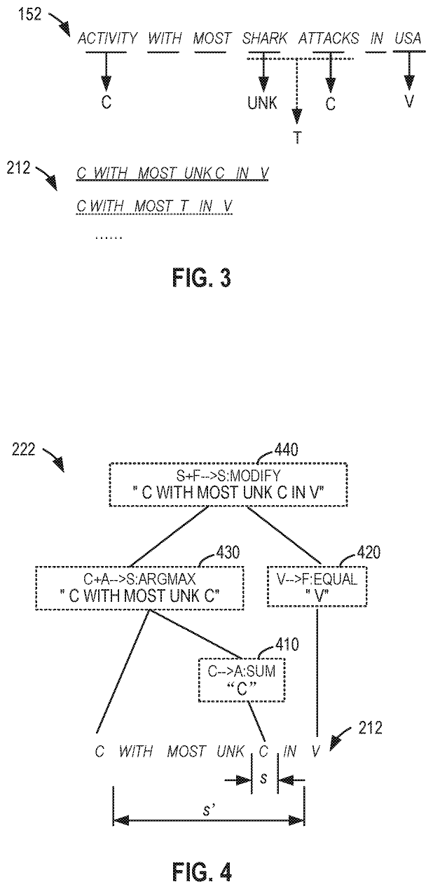

FIG. 3 shows a schematic diagram of one example of converting a natural language query 152 into an abstracted utterance 212. The natural language query 152 in FIG. 3 is a specific natural language utterance as shown in FIG. 1. After performing the word segmentation or phrase segmentation for the natural language query 152, the data abstraction module 210 determines that the word “Activity” matches the name of one column of the data set 132. The data abstraction module 210 replaces the word with a predetermined symbol indicating the name of a column, such as the symbol “C.” The data module 210 traverses the words of the natural language query 152 and identifies that the words “Attacks” and “USA” match one column of the data set 132 and one data item defined by the row and column, respectively, thus replacing the two words with predetermined symbol indicating such table information respectively, for example, symbols “C” and “V.”

The data abstraction module 210 may also identify whether one or more words of the plurality of words are semantically matched to the predetermined symbols, and replace the word(s) with the predetermined symbol(s) indicating the important words when semantically matched. Still taking FIG. 3 as an example, the data abstraction module 210 determines that the words “with,” “most,” and “in” semantically match the predetermined symbols when traversing the words of the natural language query 152, which means that their semantics are completely identical or similar. Thus, these words may be reserved as predetermined symbols. Alternatively, if these words are characterized by other different forms of predetermined symbols in the predetermined dictionary, these words may be replaced with other predetermined symbols.

If the data abstraction module 210 does not identify a match for a certain word in the natural language query 152, the word is replaced with a special predetermined symbol (e.g., the symbol “UNK”) indicating the unknown word. For example, in FIG. 3, when the data abstraction module 210 traverses to the word “Sharks” and cannot identify that the word directly matches the data in the data set or matches other predetermined symbols, the word may be replaced with the symbol “UNK.”

After the abstraction based on predetermined symbols, the data abstraction module 210 may convert the natural language query 152 into the abstracted utterance 212 of “C with most UNK C in V” In the data abstraction process, for one or more words, the data abstraction module 210 may identify various possible matched or unmatched results. For example, as for the phrase “Shark attacks” in the natural language query 152, in addition to being replaced with two predetermined symbols “UNK C,” the data abstraction module 210 also identifies that the phrase matches the table name in the data set 132, The phrase is thus replaced with a predetermined symbol indicating table name, such as the symbol “T.” By performing the replacement with different groups of predetermined symbols, the data abstraction module 210 may obtain more than one abstracted utterance 212, such as another abstracted utterance of “C with most T in V.”

In some implementations, the data abstraction module 210 may use one or more matching techniques, such as string matching, word stem matching, synonym/synonym matching, in the process of performing semantic matching with data in a data set or with the predetermined symbols.

During the data abstraction process, it is possible to extract table-related information, important words and the like from the natural language query 152, and replace an unknown word that is absent from the predetermined dictionary with a special predetermined symbol (UNK). In this way, natural language queries with more possible vocabulary are confined to limited vocabulary, which facilitates subsequent semantic parsing to be performed independent of data quickly. Although the vocabulary is limited, since the reserved words/symbols are all suitable for characterizing specific semantics in the context of a data query for a table, they can still be used to support correct semantic parsing.

### Semantic Parsing

To generate a logical representation to facilitate semantic parsing, the semantic representation module 220 applies different deduction rules to the abstracted utterance 210. These deduction rules may also be set on the basis of predetermined symbols (i.e., metadata symbols) indicating the table-related information in the predetermined dictionary, to facilitate understanding of the semantic of the abstracted utterance composed of these predetermined symbols. As mentioned above, each deduction rule may be defined by one or more of the deduction of the deduced symbol, the predicate logic of the deduced symbol, the application condition, and the property setting rule. If a certain item in a certain deduction rule is undefined, its corresponding part may be represented as null or N/A.

Each deduction rule defines symbol converting, indicating how to deduce another symbol (which may be referred to as a deduced symbol) from the current symbol. “Deductive symbol” refers herein to a symbol deduced from a predetermined symbol in an abstracted utterance. Depending on the specific deduction rule, the deduced symbol may be selected from a metadata symbol set (such as those provided in Table 1) and another operation symbol set. The operation symbol set also contains one or more predetermined symbols that are different from the predetermined symbols in the metadata symbol set and that may be mapped to respective data analysis operations. Data analysis operations are computer interpretable and executable. Usually, the property of the predetermined symbol in the operation symbol set is “column,” and records the column in which the corresponding data analysis operation is to be performed. In some implementations, predetermined symbols in the operation symbol set are also considered as being mapped to a property and a semantic, where the semantics represent respective data analysis operations. Some examples of the operation symbol set are given in Table 2 below. However, it would be appreciated that more, fewer or different predetermined symbols are also possible.

TABLE 2
Operation symbols

| | | Semantic/data |
|---|---|---|
| Symbol | Property | analysis operation |
| A | column | aggregation |
| G | column | grouping |
| F | column | filtering |
| S | column | superlative |

The semantic of symbol A corresponds to an aggregation operation, and the property of symbol A is “column” (which may be represented as A.col) for recording one or more columns to be aggregated. The semantic of symbol G corresponds to a grouping operation, and its property “column” is used for recording one or more columns to be grouped. The semantic of symbol F corresponds to a filtering operation, and its property “column” is used for recording the column(s) to which the filtering operation is to be applied. The symbol S represents the superlative and its property “column” is used for recording the column(s) to which a superlative-taking operation is to be applied (taking a maximum, a minimum, etc.).

When applying a deduction rule, another predetermined symbol may be deduced from one or more predetermined symbols. In addition to the symbol converting, each deduction rule may also define an application condition. The application condition specifies that the deduction rule is applied (namely, the deduction rule is applied) when the predetermined symbol satisfies what condition. Whether the application condition is satisfied may be determined based on a property to which the predetermined symbol to be transformed is mapped. As for the deduced symbol obtained after the converting, it is necessary to set the property of the deduced symbol. The settings of the property may be used for subsequent further deduction. The property here may not be completely the same as the property corresponding to the original predetermined symbol.

Through the application of the deduction rules, the deduced symbols obtained from the predetermined symbols may be mapped to operations or representations in the data analysis domain, which helps the subsequently-generated logical representations to characterize a certain semantic of the natural language query. The semantic is interpretable by the computer (for example, interpreted by the predicate logic).

Before describing in detail how the semantic representation module 220 generates the logical representation 222, examples of some deduction rules applicable in the context of a data query for a table is first discussed. It would be appreciated that the specific deduction rules discussed are merely examples. In some implementations, for a plurality of predetermined symbols that make up an abstracted utterance, application deduction rules are only performed for predetermined symbols from a metadata symbol set (e.g., Table 1) because these symbols indicate table-related information. In some implementations, the deduction can continue on the basis of the previous deduction (so long as the application conditions are met), so the deduction rules may also be applied to predetermined symbols from the operation symbol set.

In some implementations, the deduction rules may be divided into two categories, depending on the deduction rules. The deduction rules of the first category are called composition deduction rules, and their definition combine two predetermined symbols into one deduced symbol. Depending on the rule setting, the deduced symbol may be identical in expression to one of the two predetermined symbols or different from both symbols. Composition deduction rules are important because they may reflect the combined characteristics in the semantic.

Some examples of composition deduction rules are given in Table 3 below.

TABLE 3
Examples of composition deduction rules

| Deduction and | | Property setting |
|---|---|---|
| predicate logic | Application condition | rule |
| C\|A\|G\|S + T → | (C\|A\|G\|S).col ⊆ T.col | \hat{T}.col = (C\|A\|G\|S).col |
| \hat{T}: [project] | | |
| F + T → \hat{T}: [filter] | F.col ⊆ T.col | \hat{T}.col = T.col |
| A\|G + C → | C.type ⊆ {string, date} | Ĝ.col = |
| Ĝ: [group] | | (A\|G).col ∪C.col |
| C + V\|D → | C.col = (V\|D).col | \hat{F}.col = C.col |
| \hat{F}: [equal] | | |
| C + N → | C.col = N.col | \hat{F}.col = C.col |
| \hat{F}: [more\|less\|≥\|≤] | | |
| F + F → | N/A | \hat{F}. col = F.col∪F.col |
| \hat{F}: [and\|or] | | |
| A + C → | C.type∈{string, date} | Ŝ.col = A.col∪C.col |
| Ŝ: [argmax\|argmin] | | |
| C₁ + C₂ → | C₁.type∈{string, date} | Ŝ.col = C₁.col ∪C₂.col |
| Ŝ: [argmax\|argmin] | C₂.type = value | |
| C + C | N/A | Ĉ.col = C.col∪C.col |
| Ĉ: [combine] | | |
| A + A | N/A | Â.col = A.col∪A.col |
| Â: [combine] | | |
| C\|A\|G\|S + F | (C\|A\|G\|S).col∩F.col = Ø | (Ĉ\|Â\|Ĝ\|Ŝ).col = |
| Ĉ\|Â\|Ĝ\|Ŝ:[modify] | | (C\|A\|G\|S).col |

In Table 3, the identifier “1” indicates that symbols on both sides of the identifier are in an “or” relationship, that is, one of them is taken. In each deduction rule, the deduced symbol is specially marked with a superscript “\hat{ },” but the deduced symbol can still be considered as a predetermined symbol in the metadata data set or the operation symbol set, although its property is specially set. In the following, the deduced symbols are sometimes not indicated using special superscripts. It is further noted that during the deduction, the order of symbols on the left and right sides of the “+” does not affect the use of the deduction rule. For example, “C+T” is the same as “T+C.”

In Table 3, the first column “Deduction and Predicate Logic” indicates that predetermined symbols on the right and their corresponding predicate logic may be deduced from two predetermined symbols on the left. These symbol converting/deduction rules primarily deduce from relational algebra, and predicate logic is mapped to operations in the field of data analysis. Predicate logic is listed in Table 3, such as project, filter, equal, greater, less, and/or, argmax/argmin or combine. The second column “Apply Condition” indicates conditions under which the deduction rules may be applied. The setting of the application conditions may come from expert knowledge. By setting the application conditions, it is possible to avoid excessive redundant use when random permutation and combination of the deduction rules is applied, thereby greatly reducing the search space. For example, as for the deduction and predicate logic “G+C→Ĝ:[group],” the application condition defines that the symbol “G” and the symbol “C” are composed as the deduced symbol “Ĝ” when the property (namely, type) of the predetermined symbol “C” belongs to a string or date.

The third column, “Property Setting Rules,” indicates how to set the properties of the deduced symbols. When the deduction rules are applied to perform parsing, the setting of the deduced symbols may be used for subsequent deductions and for the generation of computer-executable queries. For example, the property setting rule “\hat{T}.col=(C|A|G|S).col” means that the property “column” of the deduced symbol \hat{T} will be set as column names recorded by the property “column” of the predetermined symbol C, A, G or S.

In addition, a modification operation is introduced in the composition deduction rules. This symbol is based on the X-bar theory about constituency grammar in the field of semantic parsing. Based on this theory, in a phrase, certain words with some modifiers may be considered as central words. This may be for example expressed as NP:=NP+PP. The inventor has found upon designing the composition deduction rules in the data query scenario that certain predetermined symbols, such as F and S, may be composed into one of the predetermined symbols. The predetermined symbol is a symbol expressing its central semantic in the previous two predetermined symbols (for example, C|A|G|S+F→Ĉ|Â|Ĝ|Ŝ:[modify]). The composed deduced symbol follows the property of the previous predetermined symbol, but the predicate of the modification operation is assigned to the deduced symbol. Such composition deduction rules help correctly parse the linguistic head-modifier phrasing structure. Although only some deduction rules involved in the modification operation are given in Table 3, more other deduction rules may be involved as needed.

The above composition deduction rules require that two predetermined symbols be combined into a deduction rule of a deduced symbol for generating a new semantic, but this may not be sufficient to characterize some complex semantic. It has been found that certain individual symbols can also represent important semantics. For example, in the natural language query of “Shark attacks by country,” human beings may understand from this context that the implied semantic is to summate the “attacks.” In order to enable the computer to understand such implied semantic, it is necessary to perform further deduction for the predetermined symbols corresponding to the word “attacks.” Therefore, in some implementations, deduction rules for one-to-one symbol deduction are further defined. Such deduction rules may be referred to as raising deduction rules. The raising deduction rules involve deriving another predetermined symbol indicating the table-related information from a predetermined symbol indicating the table-related information. Upon designing the raising deduction rules, it is also possible to avoid occurrence of raising grammar loops (for example, two predetermined symbols may be continuously converted to each other), which may be achieved by designing the application conditions of the deduction rules. Suppression of the raising grammar loops may effectively reduce the number of subsequently-generated logical representations.

Table 4 gives some examples of raising deduction rules. For example, the deduction rule defining the deduction rule “C→Â:[min|max|sum|ave]” allows the symbol A to be deduced from the symbol C, provided that the property type corresponding to the symbol C is a numerical value (namely, C.type=num). The deduced symbol A being mapped to the predicate logic may include various predicate logics associated with the numerical values, such as taking a minimum (min), taking a maximum (max), taking a sum (sum), and averaging. Other deduction rules in Table 4 may also be understood.

TABLE 4
Examples of raising deduction rules

| Deduction and | | Property setting |
|---|---|---|
| predicate logic | Application condition | rule |
| C → Â: [min\|max\|sum\|avg] | C.type∈ numerical value | Â.col = C.col |
| C → Â: [count] | C.type∈{string, date} | Â.col = C.col |
| V\|D → \hat{F}: [equal] | N/A | \hat{F}.col = (V\|D).col |

Examples of different deduction rules are discussed above. It would be appreciated that more, fewer, or different deduction rules may be set based on expert knowledge and specific data query scenarios. According to the above deduction rules, the deduced symbols indicate table-related information or indicate examples of predetermined symbols of different operations for the table, so they may be represented by predetermined symbols. In Tables 3 to 4, variant representations of the deduced symbols are listed for the purpose of distinction only. In some examples, the deduced symbol \hat{T} may also be represented as T, which is the same as the predetermined symbol shown in Table 1. Other deduced symbols may also be represented similarly.

The predetermined deduction rules may form a deduction rule library. During operation, the semantic representation module 220 accesses these deduction rule libraries to parse the abstracted utterance 212 with these deduction rules to generate a logical representation 222 corresponding to the predictive semantic of the natural language query 152. Upon parsing the abstracted utterance 212, the semantic representation module 220 may traverse through predetermined symbols in the abstracted utterance 212 to determine whether composition deduction rules may be applied to a pair of symbols (as in Table 3), and/or whether raising deduction rules (see Table 4) may be applied to a single symbol. Whether a deduction rule may be applied depends on whether the application condition of the deduction rule is satisfied. In some implementations, according to the definitions of the deduction rules, the semantic representation module 220 only needs to perform judgment for predetermined symbols which are from the metadata symbol set and contained in the abstracted utterance 212, without having to consider semantically-matched predetermined symbols or special symbols (these symbols will be taken into account as context information when selecting a logical representation, as described below). During this traversal, some predetermined symbols or symbol combinations may satisfy the application conditions of a plurality of deduction rules. Thus, different deduction rule sets (including one or more deduction rules) may be used to generate different logical representations 222.

In the examples in Table 3 and Table 4 above, the deduction rules defined by the predetermined deduction rules may be expressed in the following two categories:

(X₁,s₁)[t₁]+(X₂,s₂)[t₂]→(\hat{X},s₁ [symbol] s₂)[\hat{t}] (1)

(X,s)[t]→(\hat{X},s)[\hat{t}] (2)

where X represents a predetermined symbol, l represents a predicate logic corresponding to a predetermined symbol, and s represents an abstracted utterance portion containing the predetermined symbol.

Formula (1) represents deriving another predetermined symbol (namely, a deduced symbol) from two adjacent predetermined symbols, and the abstracted utterance corresponding to the deduced symbol is a connection (namely, s₁ [symbol] s₂) of abstracted utterances corresponding to the previous two adjacent predetermined symbols. Formula (2) indicates deriving another predetermined symbol (i.e., a deduced symbol) from one predetermined symbol, and the abstracted utterances corresponding to the deduced symbol and the predetermined symbol before the deduction are partially the same. Therefore, after execution of the semantic parsing algorithm is completed, each node on a semantic parse tree consists of two parts: a deduction rule (the deduced symbol, a corresponding predicate logic and a property), and an abstracted utterance portion corresponding to the deduction rule. The underlying of the semantic parse tree is the predetermined symbols of the abstracted utterances.

In some implementations, the semantic representation module 220 may use bottom-up semantic parsing to parse a plurality of semantic parse trees from the abstracted utterance 212 as a plurality of logical representations. The semantic representation module 220 may utilize various techniques of semantic parsing methods to generate the logical representations. The nodes of each semantic parse tree include deduced symbols and predicate logic corresponding to the deduced symbols obtained after the corresponding deduction rule sets are applied. In some implementations, the nodes of each semantic parse tree may also include obtaining an abstracted utterance portion corresponding to the deduced symbols, namely, an abstracted utterance portion to which the deduced symbols are mapped. Each semantic parse tree may be considered as corresponding to a prediction semantic of the natural language query 152.

In some implementations, for each abstracted utterance 212, by employing the bottom-up semantic parsing, it is possible to start from a plurality of predetermined symbols it contains and apply a deduction rule to obtain a deduced symbol when the application condition of the deduction rule is satisfied until the last deduced symbol is obtained as a vertex of the semantic parse tree. For example, the bottom-up semantic parsing of the abstracted utterance 212 may be performed using a CKY algorithm. The use of the CKY algorithm may enable dynamic planning and accelerates the reasoning process. In addition, any other algorithm capable of supporting implementation of the bottom-up semantic parsing based on specific rules may also be employed. The scope of implementation of the subject matter described herein is not limited in this regard.

In the process of generating the semantic parse tree, the semantic representation module 220 makes different choices when the application conditions of the plurality of deduction rules are satisfied, so that different semantic parsing trees may be obtained. Basically, the semantic representation module 220 searches for all possible logical representations defined in accordance with the deduction rules. In this way, all possible semantics may be predicted for the natural language query 152. Since the number of possible predetermined symbols in the abstracted utterance is limited, and different deduction rules are triggered under certain conditions, rather than unconditionally, in the implementation of the subject matter described herein, the search space of the semantic parse tree is limited, which may improve the efficiency of generation of the logical representations and subsequent operations. At the same time, the design of predetermined symbols and deduction rules may also ensure the flexibility and expressiveness of the grammar, thus maintaining the accuracy of semantic parsing.

FIG. 4 shows an example of parsing the abstracted utterance 212 “C with most UNK C in V” into a semantic parse tree 222. By traversing the predetermined symbols of the abstracted utterance 212, the semantic representation module 220 determines that the predetermined symbol “C” conforms to an application condition of a raising deduction rule (e.g., the first row of deduction rule in Table 4) (because the property of the symbol “C” is marked as a numerical value), so the deduced symbol “A” is deduced from the predetermined symbol “C” and a predicate logic, namely, “sum,” is selected. This may be represented as “C→A:[sum].” It is noted that the deduced symbol “A” may also correspond to another predicate logic, but will be selected in another semantic parse tree. Thus, one node 410 of the semantic parse tree 222 is represented as “C→A:[sum]” and also indicates a portion “C” of the corresponding abstracted utterance 212. The semantic representation module 220 also determines that the predetermined symbol “C” in the abstracted utterance 212 and the deduced symbol “A” corresponding to the node 410 conform to an application condition (namely, the property of symbol C is marked as a numerical value) of a composition deduction rule (e.g., a deduction rule corresponding to the deduction and predicate logic “A+C→S:argmax” in Table 4”), so it is possible to determine a node 430 of the semantic parse tree, which represents the deduction and predicate logic “A+C→S:argmax” and two symbols for synthesis are mapped to a portion “C with most UNK C” of the abstracted utterance 212.

In addition, the semantic representation module 220 further determines that the predetermined symbol “V” conforms to an application condition (namely, triggered so long as the symbol V is encountered) of a raising deduction rule (e.g., the deduction rule corresponding to the deduction and predicate logic “V→F:[equal]” in Table 4), so a node 420 of the semantic parse tree can be determined, which represents the deduction and predicate logic “V→F:[equal]” and the corresponding portion “V” of the abstracted utterance 212. The semantic representation module 220 may also continue to determine that the deduced symbols “S” and “F” conform to an application condition (namely, S. col∩F.col=Ø) of a composition deduction rule (e.g., a deduction rule corresponding to the deduction and predicate logic “S+F→S [modify]” in Table 3), so a node 440 of the semantic parse tree may be determined, which represents the deduction and predicate logic “S+F→S [modify]” and two symbols for composition are mapped to the portion “C with most UNK C in V” in the abstracted utterance 212.

After a plurality of possible deduction rules are applied, a semantic parse tree 222 as shown in FIG. 4 is formed. The nodes of the semantic parse tree 222 include deduced symbols obtained after the corresponding deduction rules are applied, predicate logic corresponding to the deduced symbols, and the portion of the abstracted utterance 212 to which the deduced symbols are mapped back. Each node in the semantic parse tree 222 may correspond to a certain semantic that is considered to be the predictive semantic of the natural language query 152.

### Selection of Logical Representation

The semantic representation module 220 can generate a plurality of logical representations 222 for each of the one or more abstracted utterances obtained by the data abstraction module 210 by traversing the deduction rule library. The selection module 230 is configured to select from these logical representations a logical representation 232 for generating a computer-executable query. It is desirable that the logical representation selected is better matched to the actual semantic of the natural language query 152. Since the semantic space has been searched as much as possible after traversing the predetermined symbols and deduction rules, a logical representation is used to characterize the possible semantic of the natural language query 152. By measuring the semantic confidence of the logical representations, it is possible to select a logical representation with a higher probability to match the actual semantic.

In some implementations, for each of the plurality of logical representations 222, the selection module 230 determines the semantic confidence of each of the deduction rules used in generating the logical representation, and then based on the semantic confidences of a plurality of deduction rules used in generating the logical representation, determines the semantic confidence of the predictive semantic corresponding to the logical representation. The selection module 230 may select one logical representation 232 based on the semantic confidences of the predictive semantics of the plurality of logical representations 222. For example, the selection module 230 may sort these semantic confidences and select a logical representation with a higher (or highest) semantic confidence. In some implementations, if there are a plurality of abstracted utterances 212 and logical representations 222 parsed from the respective abstracted utterances 212, the selection module 230 may first select a logical representation from the plurality of logical representations parsed by each abstracted utterance (e.g., by calculating and sorting of semantic confidences), and then sort the logical representations selected for the plurality of abstracted utterances, and then select therefrom the logical representation with higher (or highest) semantic confidence.

In some implementations, an extension-based analysis method may be employed in order to obtain more context information when determining the semantic confidence of each deduction rule. Specifically, each of the deduced symbols corresponding to a portion of the abstracted utterance may represent a symbol width of the deduced symbol, which may be represented as “S.” Upon determining the semantic confidence, the selection module 230 may identify that a portion of the logical representation generated by each deduction rule (e.g., each node of the semantic parse tree) is mapped to a portion of the abstracted utterance, such as a portion identified by the node when the semantic parse tree is generated). The selection module 230 can expand the corresponding portion to obtain an expanded portion of abstracted utterance 212. In some implementations, the selection module 230 may expand the abstracted utterance 212 from both directions until a particular symbol is encountered. In the example of FIG. 4, as for node 410, assuming that a corresponding portion of the abstracted utterance (namely, symbol “C”) is expanded from “s” to “s′,” the obtained expanded portion comprises predetermined symbols “with most UNK” and “in” in the context of the abstracted utterance 212, in addition to the predetermined symbol “C.”

The selection module 230 may extract a feature of the expanded portion of the abstracted utterance 212 and determine the semantic confidence of the deduction rule based on the extracted features and vectorized representations of the deduction rules. The semantic confidence indicates the contribution of the deduction rule to the parsing of the actual semantic of the natural language query 152, which also means whether it is reasonable to apply the deduction rule here and whether it helps understand the actual semantic of the natural language query 152.

In some implementations, the selection module 230 may use a pre-configured learning model such as a neural network to perform feature extraction of the expanded portion and determination of the confidence of each deduction rule. The neural network is configured to include a plurality of neurons, each of which processes the input based on parameters obtained from the training and generates an output. The parameters of all neurons of the neural network form a parameter set of the neural network. When the parameter set of the neural network is determined, the neural network may be operated to perform the corresponding function. In this context, a neural network may also be referred to as a “learning network” or a “neural network model.” In the following, the terms “learning network,” “neural network,” “neural network model,” “model” and “network” are used interchangeably.

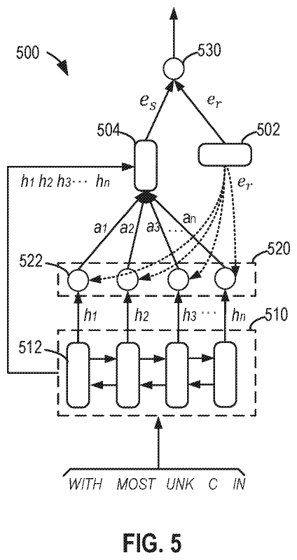

FIG. 5 shows a schematic diagram of a neural network 500 for determining a semantic confidence according to an implementation of the subject matter described herein. Input of the neural network 500 includes expanded context information corresponding to a deduction rule identified from the abstracted utterance 212, for a particular deduction rule. In some implementations, each symbol in the vocabulary may be encoded as a corresponding vectorized representation, and these vectorized representations are used to distinguish symbols in the vocabulary. In some implementations, the neural network 500 includes a first sub-network 510 for extracting features of an expanded portion (e.g., a portion “with most UNK C in” of the abstracted utterance 212). The first sub-network 510 extracts corresponding features from the expanded portion (e.g., a vectorized representation of the expanded portion). In some implementations, the first sub-network 510 may be designed as a Long Short-Term Memory (LSTM) sub-network that includes a plurality of LSTM neurons 512 for performing extraction of hidden feature representations. In one example, the number of LSTM neurons may be the same as or more than the number of symbols in the expanded portion. In other implementations, other similar neurons may also be used to perform the extraction of hidden feature representations. The hidden features extracted by the first sub-network 510 may be expressed as h₁, . . . hₙ (where n corresponds to the number of LSTM neurons).

The neural network 500 further includes a second sub-network 520 for determining attention weights of the feature of the expanded portion based on an attention mechanism under specific deduction rules. The second sub-network 520 includes a plurality of neurons 522, each of which is configured to use corresponding parameters to perform processing of the input to generate an output. Specifically, the second sub-network 520 receives the hidden features h₁, . . . hₙ extracted by the first sub-network 510 from the expanded portion and determines the attention weights corresponding to the respective features.

The neural network 500 may include a vectorization module 502 for determining a vectorized representation of each deduction rule. The vectorized representation of the deduction rule may characterize the deduction rule in a manner different from other deduction rules. In one example, each deduction rule r (where r represents an identity of the deduction rule) may be encoded as a dense vector, represented as eᵣ=Wfᵣ, where matrix W is a parameter set of the vectorization module 502, fᵣ is a sparse vector of the deduction ruler, fᵣ∈{0,1}^{d}, used to identify the deduction ruler from the plurality of deduction rules. The vectorization module 502 processes a coefficient vector representation of each deduction rule by using the preset parameter set W.

In the second sub-network 520, each neuron 522 receives a dense vector eᵣ of deduction rules and the hidden features h₁, . . . hₙ extracted from the first sub-network 510, and then processes the input with a pre-configured set of parameters. This may be expressed as:

$$\begin{matrix}{u}_{i} = {θ}^{⊤} tanh ( {W}_{1} {h}_{i} + {W}_{2} {e}_{r} ) & ( 5 ) \\ {a}_{i} = \frac{exp ( {u}_{i} )}{{\sum }_{j = 1}^{n} exp ( {u}_{j} )} & ( 6 )\end{matrix}$$

where the vector θ and W₁ and W₂ are the parameter set of the second learning sub-network 520. The attention weights a₁, . . . aₙ of the second learning sub-network 520 are used to weight to the hidden feature representation h₁, . . . hₙ output by the first sub-network 510 to generate a final feature of the expanded portion. This may be accomplished by a weighting module 504. The determination of the final a feature of the expanded portion may be expressed as:

$${e}_{s} = {\sum }_{i = 1}^{n} {a}_{i} {h}_{i} \qquad ( 7 )$$

By means of the attention weights a₁, . . . aₙ, when a deduction rule is given, some more noteworthy feature representations in the hidden feature representations may be obtained to serve as the final feature of the expanded portion.

The neural network 500 further includes a confidence calculation module 530 for determining the semantic confidence of the deduction rule based on the feature of the expanded portion and the vectorized representation of the deduction rule. The calculation of semantic confidence may be expressed as ϕ(eᵣ_{ᵢ}, eₛ_{ᵢ}), where ϕ( ) represents a function for confidence calculation. The confidence calculation module 530 may perform the confidence calculation by using an arbitrary scoring function (e.g., a point multiplication, a cosine similarity calculation function, a bilinear similarity calculation function, and the like).

FIG. 5 provides an example of determining the semantic confidence of each deduction rule based on the neural network 500. The training of the neural network 500 will be described below. It would be appreciated that the neural network shown in FIG. 5 is only an example. In other implementations, the determination of the confidence of the deduction rules may be implemented using neural networks that are constructed in other forms.

For a given logical representation 222, after the semantic confidence of each deduction rule is determined, for example, by using a neural network-based model, in some implementations, the selection module 230 determines the semantic confidence of the predictive semantic corresponding to the logical representation by summating the semantic confidences of the deduction rule set of the given logical representation 222 and then performing exponential transformation. The semantic confidence indicates a probability that the predictive semantic corresponding to a given logical representation reflects the actual semantic of the natural language query 152. In some implementations, the semantic confidence may be in a function relationship to a sum of the semantic confidences of the deduction rule set. For example, the selection module 230 may utilize a log linear model to calculate the semantic confidence of the predictive semantic corresponding to logical representation 222, which may be expressed as:

$$p ( Z \vert x ) ∝ exp ( {\sum }_{{z}_{i} = ( {r}_{i} , {s}_{i} ) ∈ Z} φ ( {e}_{{r}_{i}} , {e}_{{s}_{i}} ) ) \qquad ( 8 )$$

where p(Z|x) represents the semantic confidence, which indicates a probability that the predictive semantic corresponding to a logical representation Z reflects the true semantic of the natural language query x, ∝ represents a proportional relationship, and exp( ) represents an exponential function with a natural constant e as the base, and zᵢ represents a deduction rule used for parsing the logical representation Z. It may be determined from Formula (8) that the semantic confidence is related to the semantic confidence of the deduction rule used to generate a logical representation.

For each logical representation of each abstracted utterance, the implementations described above may be applied to determine the semantic confidences of the predictive semantics corresponding to the logical representations. The selection module 230 then selects a logical representation based on the semantic confidences of the logical representations to generate a computer-executable query. As mentioned above, it is possible to first perform the selection of the logical representation one time from the logical representation parsed by each abstracted utterance 212, and then select the logical representation with the optimal semantic confidence across the plurality of abstracted utterances 212. Since the selection of the logical representation is first performed on the basis of the abstracted utterances, in some implementations, it is possible to perform the generation of the abstracted utterances, the parsing of the abstracted utterances to the logical representations, and the calculation of the semantic confidences in parallel. This may further improve efficiency of the semantic parsing.

In some of the above implementations, a neural network-based model may be used to determine the semantic confidence of a single deduction rule and further to determine the semantic confidence of the logical representation. In order to configure a parameter set of such a neural network model (such as the above parameters W, θ, W₁, W₂ and so on), the neural network model (e.g., neural network 500) may be trained using training data. The training samples may include a training data set (represented as tᵢ) organized as a table, a training natural language query (represented as xᵢ) for the training data set, and a corresponding real/correct computer-executable query (e.g., a SQL query, represented as yᵢ), such training data may be expressed as (xᵢ, yᵢ). To train the model, a plurality of training samples may be used, which means that i may be valued as being greater than one.

For each training natural language query xᵢ, a corresponding plurality of logical representations may first be determined by data abstraction module 210 and semantic representation module 220. These logical representations are all valid logical representations. To measure whether the current parameter set of the neural network 500 is accurate, each valid logical representation may be converted to a training computer-executable query (e.g., a SQL query). The training computer-executable query is compared with a ground-truth computer-executable query, and the corresponding logical representation may be considered as a consistent logical representation if the two queries are equivalent. The logical representation is considered an inconsistent logical representation if two computer-executable queries are not equivalent.

In some implementations, the training process may determine convergence by determining an objective function (such as a loss function or cost function) for the neural network 500 and optimizing the objective function (e.g., minimizing a loss function or maximizing a cost function). In an example based on a loss function, if training data {(xᵢ,tᵢ,yᵢ)}ᵢ₌₁^{N} (where N represents the number of training samples) is given, the loss function of neural network 500 may be for example determined as:

$$L = {\sum }_{i = 1}^{N} {max ( 0 , α - {p ( {Z}^{+} \vert {x}_{i} )}^{*} + p ( {Z}^{-} \vert {x}_{i} ) )}^{*} \qquad ( 9 )$$

where p(Z⁺|xᵢ)* represents the highest semantic confidence of the consistent logical representation obtained from training the natural language query xᵢ, which is determined based on the current parameter set of the neural network 500; {Zⱼ⁻, j=1 . . . m} represents an inconsistent logical representation obtained from training the natural language query xᵢ; and α is a margin parameter (which may be set to any value from 0 to 1, such as 0.5, 0.4, 0.6, etc.). During the training process, the parameter update and model convergence may be continuously implemented by penalizing the inconsistent logical representation and rewarding the most consistent logical representation. This also helps to prevent from over-fitting in the case of a small data set and weak supervision and achieves full utilization of the existing data. In some implementations, the training of neural network 500 may be implemented using any model training methods that currently exist or to be developed in the future. The scope of the subject matter described herein is not limited in this regard.

In the above-described process of training a neural network, the computer-executable query corresponding to each training natural language query is used as training data. In other implementations, the corresponding real/correct query results of the training natural language query may also be used as ground-truth data for measuring whether the parameter set has been converged during the training process.

### Machine Interpretation of Logical Representation

The logical representation 232 selected by the selection module 230 (e.g., a logical representation generated from the abstracted utterance “C with most UNK C in V”) may be used to generate the computer-executable query. The computer-executable query may be generated in the computing device 100, for example, by an additional module included in parsing module 122 or by a module separate from the parsing module 122. The selected logical representation 232 may also be provided to other devices to generate the computer-executable query, such as the computer-executable query 124 in FIG. 1.

The logical representation 232 is in a computer-interpretable representation form obtained after performing the semantic parsing on the natural language query 232 because the symbols in the logical representation 232 and the deduction rules are all mapped to corresponding properties and/or semantics. Therefore, a computer can easily convert the logical representation 232 to a computer-executable query (such as a SQL query) written in a machine query language. Various methods may be used to implement the generation of the computer-executable query.

When the logical representation 232 is interpreted as a computer-executable query, the predicate logic corresponding to the deduced symbol in the logical representation 232 may be used. Semantically, in the scenario of data query, the relational algebra is a procedural query language that is organized as a dataset or data subset of a table as input and produces other tables. For example, a simple logical representation project(group(A, C), T) based on a semantic parse tree may be interpreted as: grouping columns of table T based on the values on column C; for each group, it produces an aggregate operation A to return a new table. It may be seen that the logical interpretation is from top to bottom, whereas the semantic analysis process is from bottom to top. In some implementations, for the deduction rules that may be involved in a logical representation, it may be specified that nodes that only involve predicate logic associated with project or select are directly interpretable. It may be believed that other nodes in the logical representation only contain part of the logic and therefore cannot be directly interpreted. In the up-bottom interpretation process, if a node that cannot be directly interpreted is encountered, it is possible to first reserve the interpretation of such a node until a node related to project or select is encountered. In other words, during the interpretation of the logical representation, the node related to project or select may trigger the predicate logic of all its sub-nodes. Such an interpretation process may be referred to as a lazy-interpreting mechanism, which can facilitate better generation of computer-executable queries.

The generated computer-executable query may be executed (for example, by the query module 126 of the computing device 100) as required to analyze the data set to which the natural language query 152 aims and obtain a query result, such as the query result 162 in FIG. 1. It would be appreciated that implementations of the subject matter described herein do not limit the execution of computer-executable query 162.

### Example Process

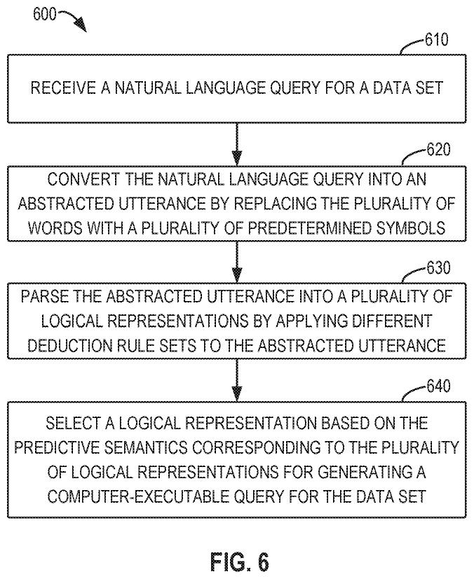

FIG. 6 illustrates a flowchart of a process 600 for parsing a natural language query in accordance with some implementations of the subject matter described herein. Process 600 may be implemented by the computing device 100, for example, may be implemented at the parsing module 122 in the memory 120 of the computing device 100. At 610, the computing device 100 receives a natural language query for a data set. The natural language query comprises a plurality of words, and the data set is organized as a table. At 620, the computing device 100 converts the natural language query into an abstracted utterance by replacing the plurality of words with a plurality of predetermined symbols. At 630, the computing device 100 parses the abstracted utterance into a plurality of logical representations by applying different deduction rule sets to the abstracted utterance, each logical representation corresponding to a predicted semantic of the natural language query. At 640, the computing device 100 selects a logical representation based on the predictive semantics corresponding to the plurality of logical representations for generating a computer-executable query for the data set.

In some implementations, converting the natural language query into the abstracted utterance comprises at least one of: in response to identifying that a first word of the plurality of words matches data in the data set, replacing the first word with a first predetermined symbol in a metadata symbol set, the first predetermined symbol being mapped to a property and a semantic related to the data; in response to identifying that a second word of the plurality of words semantically matches with a second predetermined symbol, replacing the second word with the second predetermined symbol; and in response to identifying no match for a third word of the plurality of words, replacing the third word with a third predetermined symbol, the third predetermined symbol indicating an unknown word.

In some implementations, the data comprises one of a table name, a column name, a row name, and a table entry defined by a row and a column of the data set.

In some implementations, each deduction rule in the deduction rule set defines at least one of: an application condition of the deduction rule, deduction of a deduced symbol from at least one predetermined symbol, the deduced symbol being selected from the metadata symbol set and an operation symbol set, the operation symbol set containing additional predetermined symbols, the additional predetermined symbols being mapped to respective data analysis operations, a predicate logic corresponding to the deduced symbol, and a property setting rule defining how to set a property of the deduced symbol.

In some implementations, the deduction of the deduced symbol from the at least one predetermined symbol comprises one of: composing two predetermined symbols into the deduced symbol, or replacing a single predetermined symbol with the deduced symbol.

In some implementations, parsing the abstracted utterance into the plurality of logical representations comprises: parsing a plurality of semantic parse trees from the abstracted utterance as the plurality of logical representations by using bottom-up semantic parsing, nodes of each semantic parse tree comprising deduced symbols obtained after applying the respective deduction rule set and predicate logics corresponding to the deduced symbols.

In some implementations, selecting the logical representation comprises: for each of the plurality of logical representations: determining a semantic confidence of each deduction rule in the deduction rule set from which the logical representation is parsed in the context of the abstracted utterance, and determining a semantic confidence of the predictive semantics corresponding to the logical representation by summating semantic confidences of the deduction rule set; and selecting the logical representation by comparing the semantic confidences of the predictive semantics corresponding to the plurality of logical representations.

In some implementations, determining the semantic confidence of each deduction rule comprises: identifying that a portion of the logical representation generated by applying the deduction rule is mapped to a portion of the abstracted utterance; extending the identified portion in the abstracted utterance to obtain an expanded portion in the abstracted utterance; extracting a feature of the expanded portion; and determining the semantic confidence of the deduction rule based on the extracted feature and a vectorized representation of the deduction rule.

In some implementations, the extracting of the feature and the determining of the semantic confidence are performed using a pre-configured neural network.

In some implementations, the abstracted utterance is a first abstracted utterance and the plurality of logic representations are a first plurality of logical representations, and selecting the logical representation comprises: converting the natural language query into a second abstracted utterance by replacing the plurality of words with a second plurality of predetermined symbols, the second abstracted utterance being different from the first abstracted utterance; parsing the second abstracted utterance into a second plurality of logical representations by applying different deduction rule sets to the second abstracted utterance, each logic logical representation corresponding to a predictive semantic of the natural language query; selecting a first logical representation from the first plurality of logical representations and a second logical representation from the second plurality of logical representations; and determining the logical representation from the first and second logical representations for generating the computer-executable query.

### Example Implementations

Some example implementations of the subject matter described herein are listed below.

In one aspect, the subject matter described herein provides a computer-implemented method. The method comprises: receiving a natural language query for a data set, the natural language query comprising a plurality of words, and the data set being organized as a table; converting the natural language query into an abstracted utterance by replacing the plurality of words with a plurality of predetermined symbols; parsing the abstracted utterance into a plurality of logical representations by applying different deduction rule sets to the abstracted utterance, each logical representation corresponding to a predictive semantic of the natural language query; and selecting a logical representation based on the predictive semantics corresponding to the plurality of logical representations for generating a computer-executable query for the data set.

In some implementations, converting the natural language query into an abstracted utterance includes at least one of: in response to identifying that a first word in a plurality of words matches the data in the data set, replacing the first word with a first predetermined symbol in a metadata symbol set, the first predetermined symbol being mapped to a property and a semantic related to the data; in response to identifying that a second word of the plurality of words semantically matches with a second predetermined symbol, replacing the second word with a second predetermined symbol; and in response to identifying no match for a third word of the plurality of words, replacing the third word with a third predetermined symbol, the third predetermined symbol indicating an unknown word.

In some implementations, the data includes one of: a table name of the data set, a column name, a row name, and a table entry defined by a row and a column.

In some implementations, each deduction rule in the deduction rule set defines at least one of: an application condition of the deduction rule, the deduced symbol is deduced from at least one predetermined symbol, the deduced symbol is selected from a metadata symbol set and an operation symbol set, the operation symbol set contains additional predetermined symbols, the additional predetermined symbols are mapped to respective data analysis operations; predicate logic corresponding to the deduced symbols; and a property setting rule defining how to set properties to which the deduced symbols are mapped.

In some implementations, deriving the deduced symbol from the at least one predetermined symbol includes one of: composing two predetermined symbols into a deduced symbol, or replacing a single predetermined symbol with a deduced symbol.

In some implementations, parsing the abstracted utterance into the plurality of logical representations includes: using bottom-up semantic parsing to parse a plurality of semantic parse trees from the abstracted utterance as a plurality of logical representations, nodes of each semantic parse tree including deduced symbols obtained after the corresponding deduction rule set is applied, and predicate logic corresponding to the deduced symbols.

In some implementations, selecting the logical representation includes: for each of the plurality of logical representations: determining a semantic confidence of each deduction rule in the deduction rule set of the logical representation in the context of the abstracted utterance, and determining the semantic confidence of predictive semantics corresponding to the logical representation by summating semantic confidences of the deduction rule set; and selecting the logical representation by comparing the semantic confidences of the predictive semantics corresponding to the plurality of logical representations.

In some implementations, determining the semantic confidence of each deduction rule includes: identifying that a portion of the logical representation generated by applying the deduction rule is mapped to a portion of the abstracted utterance; extending the identified portion in the abstracted utterance to obtain an expanded portion in the abstracted utterance; extracting a feature of the expanded portion; and determining the semantic confidence of the deduction rule based on the extracted feature and a vectorized representation of the deduction rule.

In some implementations, the extraction of features and the determination of semantic confidence are performed using a pre-configured neural network.

In some implementations, the abstracted utterance is a first abstracted utterance and the plurality of logic representations are a first plurality of logical representations, and selecting the logical representation comprises: replacing a plurality of words with a second plurality of predetermined symbols, converting the natural language query into a second abstracted utterance, the second abstracted utterance being different from the first abstracted utterance; parsing the second abstracted utterance into the second plurality of logical representations by applying different deduction rule sets to the second abstracted utterance, each logic representing a predictive semantic of the natural language query; selecting a first logical representation from the first plurality of logical representations and selecting a second logical representation from the second plurality of logical representations; and determining the logical representation from the first and second logical representations for generating a computer-executable query.

In another aspect, the subject matter described herein provides an electronic device. The electronic device comprises a processing unit; and a memory coupled to the processing unit and having instructions stored thereon which, when executed by the processing unit, cause the device to perform acts comprising: receiving a natural language query for a data set, the natural language query comprising a plurality of words, and the data set being organized as a table; converting the natural language query into an abstracted utterance by replacing the plurality of words with a plurality of predetermined symbols; parsing the abstracted utterance into a plurality of logical representations by applying different deduction rule sets to the abstracted utterance, each logical representation corresponding to a predictive semantic of the natural language query; and selecting a logical representation based on the predictive semantics corresponding to the plurality of logical representations for generating a computer-executable query for the data set.

In some implementations, converting the natural language query into an abstracted utterance includes at least one of: in response to identifying that a first word in a plurality of words matches the data in the data set, replacing the first word with a first predetermined symbol in a metadata symbol set, the first predetermined symbol being mapped to a property and a semantic related to the data; in response to identifying that a second word of the plurality of words semantically matches with a second predetermined symbol, replacing the second word with a second predetermined symbol; and in response to identifying no match for a third word of the plurality of words, replacing the third word with a third predetermined symbol, the third predetermined symbol indicating an unknown word.

In some implementations, the data includes one of: a table name of the data set, a column name, a row name, and a table entry defined by a row and a column.

In some implementations, each deduction rule in the deduction rule set defines at least one of: an application condition of the deduction rule, the deduced symbol is deduced from at least one predetermined symbol, the deduced symbol is selected from a metadata symbol set and an operation symbol set, the operation symbol set contains additional predetermined symbols, the additional predetermined symbols are mapped to respective data analysis operations; predicate logic corresponding to the deduced symbols; and a property setting rule defining how to set properties to which the deduced symbols are mapped.

In some implementations, deriving the deduced symbol from the at least one predetermined symbol includes one of: composing two predetermined symbols into a deduced symbol, or replacing a single predetermined symbol with a deduced symbol.

In some implementations, parsing the abstracted utterance into the plurality of logical representations includes: using bottom-up semantic parsing to parse a plurality of semantic parse trees from the abstracted utterance as a plurality of logical representations, nodes of each semantic parse tree including deduced symbols obtained after the corresponding deduction rule set is applied, and predicate logic corresponding to the deduced symbols.

In some implementations, selecting the logical representation includes: for each of the plurality of logical representations: determining a semantic confidence of each deduction rule in the deduction rule set of the logical representation in the context of the abstracted utterance, and determining the semantic confidence of predictive semantics corresponding to the logical representation by summating semantic confidences of the deduction rule set; and selecting the logical representation by comparing the semantic confidences of the predictive semantics corresponding to the plurality of logical representations.

In some implementations, determining the semantic confidence of each deduction rule includes: identifying that a portion of the logical representation generated by applying the deduction rule is mapped to a portion of the abstracted utterance; extending the identified portion in the abstracted utterance to obtain an expanded portion in the abstracted utterance; extracting a feature of the expanded portion; and determining the semantic confidence of the deduction rule based on the extracted feature and a vectorized representation of the deduction rule.

In some implementations, the extraction of features and the determination of semantic confidence are performed using a pre-configured neural network.

In some implementations, the abstracted utterance is a first abstracted utterance and the plurality of logic representations are a first plurality of logical representations, and selecting the logical representation comprises: replacing a plurality of words with a second plurality of predetermined symbols, converting the natural language query into a second abstracted utterance, the second abstracted utterance being different from the first abstracted utterance; parsing the second abstracted utterance into the second plurality of logical representations by applying different deduction rule sets to the second abstracted utterance, each logic representing a predictive semantic of the natural language query; selecting a first logical representation from the first plurality of logical representations and selecting a second logical representation from the second plurality of logical representations; and determining the logical representation from the first and second logical representations for generating a computer-executable query.

In a yet further aspect, the subject matter described herein provides a computer program product being tangibly stored in a non-transitory computer storage medium and comprising machine-executable instructions which, when executed by a device, cause the device to perform the method in the above aspect.

In a yet further aspect, the subject matter described herein provides a computer readable medium having machine executable instructions stored thereon which, when executed by a device, cause the device to perform the method in the above aspect.

The functionally described herein can be performed, at least in part, by one or more hardware logic components. As an example and without limitation, illustrative types of applicable hardware logic components include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
receiving a natural language query for a data set, the natural language query comprising a plurality of words, and the data set being organized as a table;
converting the natural language query into an abstracted utterance by replacing the plurality of words with a plurality of predetermined symbols;
parsing the abstracted utterance into a plurality of logical representations by applying different deduction rule sets to the abstracted utterance, each logical representation corresponding to a predictive semantic of the natural language query; and
selecting a logical representation based on the predictive semantics corresponding to the plurality of logical representations for generating a computer-executable query for the data set.

2. The method of claim 1, wherein converting the natural language query into the abstracted utterance comprises at least one of:
in response to identifying that a first word of the plurality of words matches data in the data set, replacing the first word with a first predetermined symbol in a metadata symbol set, the first predetermined symbol being mapped to a property and a semantic related to the data;
in response to identifying that a second word of the plurality of words semantically matches with a second predetermined symbol, replacing the second word with the second predetermined symbol; and
in response to identifying no match for a third word of the plurality of words, replacing the third word with a third predetermined symbol, the third predetermined symbol indicating an unknown word.

3. The method of claim 2, wherein the data comprises one of a table name, a column name, a row name, and a table entry defined by a row and a column of the data set.

4. The method of claim 2, wherein each deduction rule in the deduction rule set defines at least one of:
an application condition of the deduction rule,
deduction of a deduced symbol from at least one predetermined symbol, the deduced symbol being selected from the metadata symbol set and an operation symbol set, the operation symbol set containing additional predetermined symbols, the additional predetermined symbols being mapped to respective data analysis operations,
a predicate logic corresponding to the deduced symbol, and
a property setting rule defining how to set a property of the deduced symbol.

5. The method of claim 4, wherein the deduction of the deduced symbol from the at least one predetermined symbol comprises one of:
composing two predetermined symbols into the deduced symbol, or
replacing a single predetermined symbol with the deduced symbol.

6. The method of claim 1, wherein parsing the abstracted utterance into the plurality of logical representations comprises:
parsing a plurality of semantic parse trees from the abstracted utterance as the plurality of logical representations by using bottom-up semantic parsing, nodes of each semantic parse tree comprising deduced symbols obtained after applying the respective deduction rule set and predicate logics corresponding to the deduced symbols.

7. The method of claim 1, wherein selecting the logical representation comprises:
for each of the plurality of logical representations:
determining a semantic confidence of each deduction rule in the deduction rule set from which the logical representation is parsed in the context of the abstracted utterance, and
determining a semantic confidence of the predictive semantics corresponding to the logical representation by summating semantic confidences of the deduction rule set; and
selecting the logical representation by comparing the semantic confidences of the predictive semantics corresponding to the plurality of logical representations.

8. The method of claim 7, wherein determining the semantic confidence of each deduction rule comprises:
identifying that a portion of the logical representation generated by applying the deduction rule is mapped to a portion of the abstracted utterance;
extending the identified portion in the abstracted utterance to obtain an expanded portion in the abstracted utterance;
extracting a feature of the expanded portion; and
determining the semantic confidence of the deduction rule based on the extracted feature and a vectorized representation of the deduction rule.

9. The method of claim 8, wherein the extracting of the feature and the determining of the semantic confidence are performed using a pre-configured neural network.

10. The method of claim 1, wherein the abstracted utterance is a first abstracted utterance and the plurality of logic representations are a first plurality of logical representations, and selecting the logical representation comprises:
converting the natural language query into a second abstracted utterance by replacing the plurality of words with a second plurality of predetermined symbols, the second abstracted utterance being different from the first abstracted utterance;
parsing the second abstracted utterance into a second plurality of logical representations by applying different deduction rule sets to the second abstracted utterance, each logic logical representation corresponding to a predictive semantic of the natural language query;
selecting a first logical representation from the first plurality of logical representations and a second logical representation from the second plurality of logical representations; and
determining the logical representation from the first and second logical representations for generating the computer-executable query.

11. An electronic device, comprising:
a processing unit; and
a memory coupled to the processing unit and having instructions stored thereon which, when executed by the processing unit, cause the device to perform acts comprising:
receiving a natural language query for a data set, the natural language query comprising a plurality of words, and the data set being organized as a table;
converting the natural language query into an abstracted utterance by replacing the plurality of words with a plurality of predetermined symbols;
parsing the abstracted utterance into a plurality of logical representations by applying different deduction rule sets to the abstracted utterance, each logical representation corresponding to a predictive semantic of the natural language query; and
selecting a logical representation based on the predictive semantics corresponding to the plurality of logical representations for generating a computer-executable query for the data set.

12. The device of claim 11, wherein converting the natural language query into the abstracted utterance comprises at least one of:
in response to identifying that a first word of the plurality of words matches data in the data set, replacing the first word with a first predetermined symbol in a metadata symbol set, the first predetermined symbol being mapped to a property and a semantic related to the data;
in response to identifying that a second word of the plurality of words semantically matches with a second predetermined symbol, replacing the second word with the second predetermined symbol; and
in response to identifying no match for a third word of the plurality of words, replacing the third word with a third predetermined symbol, the third predetermined symbol indicating an unknown word.

13. The device of claim 11, wherein each deduction rule in the deduction rule set defines at least one of:
an application condition of the deduction rule,
deduction of a deduced symbol from at least one predetermined symbol, the deduced symbol being selected from the metadata symbol set and an operation symbol set, the operation symbol set containing additional predetermined symbols, the additional predetermined symbols being mapped to respective data analysis operations,
a predicate logic corresponding to the deduced symbol, and
a property setting rule defining how to set a property of the deduced symbol.

14. The device of claim 11, wherein the abstracted utterance is a first abstracted utterance and the plurality of logic representations are a first plurality of logical representations, and selecting the logical representation comprises:
converting the natural language query into a second abstracted utterance by replacing the plurality of words with a second plurality of predetermined symbols, the second abstracted utterance being different from the first abstracted utterance;
parsing the second abstracted utterance into a second plurality of logical representations by applying different deduction rule sets to the second abstracted utterance, each logic logical representation corresponding to a predictive semantic of the natural language query;
selecting a first logical representation from the first plurality of logical representations and a second logical representation from the second plurality of logical representations; and
determining the logical representation from the first and second logical representations for generating the computer-executable query.

15. A computer program product being tangibly stored in a computer storage medium and comprising machine-executable instructions which, when executed by a device, cause the device to perform the method according to claim 1.
